(19) United States
(12) Patent Application Publication
(10) Pub. No.: US 2012/0173254 A1
(43) Pub. Date: Jul. 5, 2012

(54) LOAD BALANCING AND ASSIGNING MEDICATION REQUESTS

(76) Inventors: Daniel J. Korhnak, North Huntingdon, PA (US); Russ Gadagno, Harrison City, PA (US); Eric Kepes, Wexford, PA (US); Chayla Whaley, Valencia, PA (US); Douglas J. Moon, Enon Valley, PA (US)

(21) Appl. No.: 12/980,747

(22) Filed: Dec. 29, 2010

(51) Int. Cl. G06Q 50/00; G06Q 10/00

(52) U.S. Cl. 705/2

(57) ABSTRACT

Systems, methods, apparatus, and computer program products are provided for load balancing medication requests. In one embodiment, a medication server may receive medications requests. The medication server may then load balance the medication requests and assign them to one or more medication filling devices for filling based at least in part on the load balancing. The one or more medication filling devices can then process and fill the assigned medication requests.

### BACKGROUND

Medication requests can be filled automatically, semi-automatically, and/or manually in accordance with workflows that define how the medication requests should be processed. When multiple medication filling devices are used to fill medication requests in accordance with a workflow, for example, it may be important to assign the medication requests to the various medication filling devices in a balanced manner. Thus, concepts are needed to load balance and assign medication requests to medication filling devices for filling.

### BRIEF SUMMARY

In general, embodiments of the present invention provide systems, methods, apparatus, and computer program products for load balancing medication requests.

In accordance with one aspect, a method for load balancing medication requests is provided. In one embodiment, the method comprises (1) identifying two or more medication filling devices for filling a plurality of unassigned medication requests; (2) identifying one or more assigned medication requests assigned to the respective medication filling devices for filling; (3) for each of the medication filling devices, determining an estimated fill time for filling the one or more assigned medication requests; and (4) assigning a first unassigned medication request of the plurality of unassigned medication requests to a selected one of the medication filling devices, wherein assigning the first unassigned medication request to the selected medication filling device is based at least in part on the estimated fill times for filling the assigned medication requests.

In accordance with yet another aspect, a computer program product for load balancing medication requests is provided. The computer program product may comprise at least one computer-readable storage medium having computer-readable program code portions stored therein, the computer-readable program code portions comprising executable portions configured to (1) identify two or more medication filling devices for filling a plurality of unassigned medication requests; (2) identify one or more assigned medication requests assigned to the respective medication filling devices for filling; (3) for each of the medication filling devices, determine an estimated fill time for filling the one or more assigned medication requests; and (4) assign a first unassigned medication request of the plurality of unassigned medication requests to a selected one of the medication filling devices, wherein assigning the first unassigned medication request to the selected medication filling device is based at least in part on the estimated fill times for filling the assigned medication requests.

In accordance with yet another aspect, an apparatus comprising at least one processor and at least one memory including computer program code is provided. In one embodiment, the at least one memory and the computer program code may be configured to, with the processor, cause the apparatus to at least (1) identify two or more medication filling devices for filling a plurality of unassigned medication requests; (2) identify one or more assigned medication requests assigned to the respective medication filling devices for filling; (3) for each of the medication filling devices, determine an estimated fill time for filling the one or more assigned medication requests; and (4) assign a first unassigned medication request of the plurality of unassigned medication requests to a selected one of the medication filling devices, wherein assigning the first unassigned medication request to the selected medication filling device is based at least in part on the estimated fill times for filling the assigned medication requests.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice various embodiments of the present invention.

FIG. 2 is an illustrative schematic diagram of a medication server according to one embodiment of the present invention.

FIG. 3 shows exemplary input/output that can be produced according to one embodiment of the present invention.

FIG. 4 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. General Overview

In general, according to various embodiments of the present invention, methods, apparatus, systems, and computer program products are provided for load balancing medication requests. In one embodiment, a server can receive medication requests from various sources, such as doctors and units in hospitals. The medication requests can be load balanced among any number of devices that can be used for filling the medication requests. As part of the load balancing, the server can determine (a) estimated times for completing work currently assigned to the devices and (b) estimated times for completing the received medication requests. Based at least in part on these estimated times, for example, the server can distribute the medication requests among the devices in a manner that will allow for efficient filling and reduce bottlenecks in the devices.

### III. Exemplary System Architecture

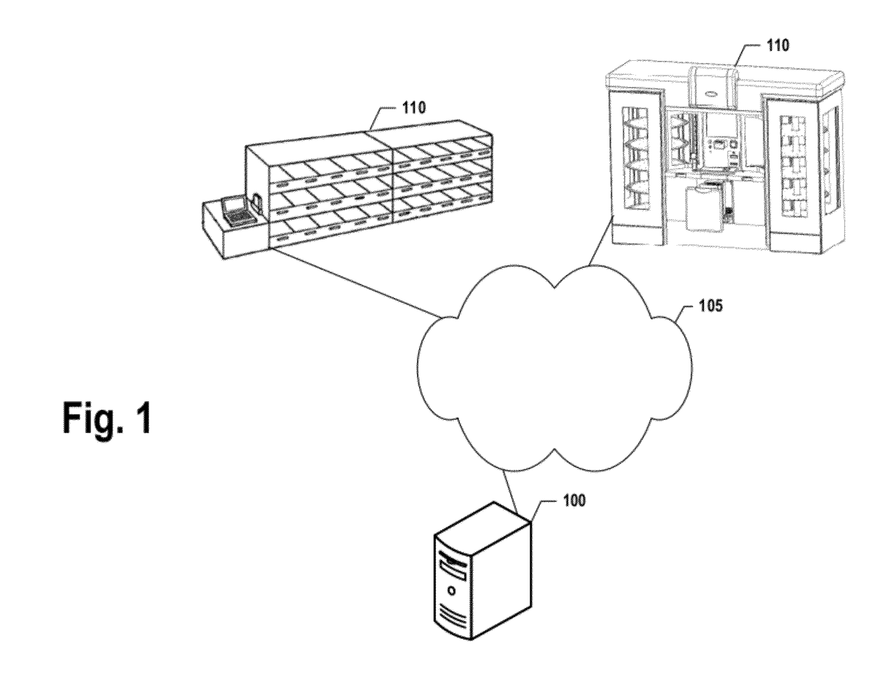

FIG. 1 provides an illustration of a system that can be used in conjunction with various embodiments of the present invention. As shown in FIG. 1, the system may include one or more medication servers 100, one or more networks 105, and/or one or more medication filling devices 110. Each of the components of the system may be in electronic communication with, for example, one another over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates certain system entities as separate, standalone entities, the various embodiments are not limited to this particular architecture.

### 1. Exemplary Medication Server

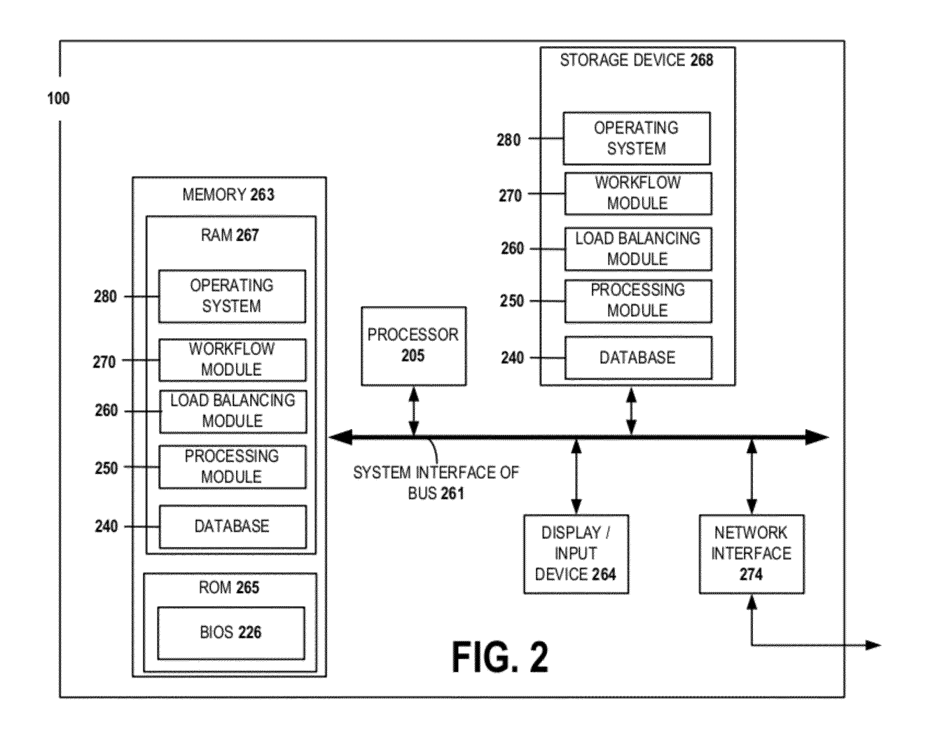

FIG. 2 provides a schematic of a medication server 100 according to one embodiment of the present invention. In general, the term “server” may refer to, for example, any computer, computing device, mobile phone, desktop, notebook or laptop, distributed system, server, blade, gateway, switch, processing device, or combination of processing devices adapted to perform the functions described herein. As will be understood from this figure, in one embodiment, the medication server 100 includes a processor 205 that communicates with other elements within the medication server 100 via a system interface or bus 261. The processor 205 may be embodied in a number of different ways. For example, the processor 205 may be embodied as a processing element, a coprocessor, a controller or various other processing devices including integrated circuits such as, for example, an application specific integrated circuit (“ASIC”), a field programmable gate array (“FPGA”), a hardware accelerator, or the like.

In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the medication server 100. This display device/input device 264 may be, for example, a keyboard or pointing device that is used in combination with a monitor. The medication server 100 may further include transitory and non-transitory memory 263, which may include both random access memory (“RAM”) 267 and read only memory (“ROM”) 265. The medication server's ROM 265 may be used to store a basic input/output system (“BIOS”) 226 containing the basic routines that help to transfer information to the different elements within the medication server 100.

In addition, in one embodiment, the medication server 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, a workflow module 270, a load balancing module 260, and a processing module 250. As discussed in more detail below, these modules may control certain aspects of the operation of the medication server 100 with the assistance of the processor 205 and operating system 280—although their functionality need not be modularized. In addition to the program modules, the medication server 100 may store or be in communication with one or more databases (e.g., database 240).

Also located within the medication server 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the medication server 100 may be configured to communicate via wireless external communication networks using any of a variety of protocols, such as 802.11, general packet radio service (“GPRS”), wideband code division multiple access (“W-CDMA”), Long Term Evolution (“LTE”), IEEE 802.11 (“Wi-Fi”), 802.16 (“WiMAX”), ultra wideband (“UWB”), and/or any other wireless protocol.

It will be appreciated that one or more of the medication server's 100 components may be located remotely from other medication server 100 components. Furthermore, one or more of the components may be combined and additional components performing functions described herein may be included in the medication server 100.

### 2. Exemplary Medication Filling Devices/Systems

As shown in FIG. 1, the system may include one or more medication filling devices 110. A medication filling device 110 may be a device, apparatus, robot, system, computer, and/or the like that can be used in filling medication requests. For example, a medication filling device 110 may be a ROBOT-Rx® automated medication dispensing system, MedCarousel® system, MedShelf system, IntelliShelf-Rx® system, PROmanager-Rx™ pharmacy automation system, PACMED™ high-speed packager, Satellite Replenishment system, Fulfill-Rx™ solution, and/or the like. Thus, as will be recognized, medication filling devices 110 may operated automatically, semi-automatically, and/or manually and include various components such as (1) processing elements, (2) memory, (3) network interfaces, (4) transceivers, (5) display devices/input devices, input and/or (6) various other components.

By way of example, in one embodiment, a pharmacist or pharmacy technician may use a MedCarousel®, MedShelf, or similar, system to manually pick medications to fill medication requests. For example, the MedShelf system may receive (e.g., from the medication server 100) and display medication requests that are assigned to a particular medication filling device 110, pharmacist, and/or pharmacy technician for filling. Using the MedShelf system, the pharmacist or pharmacy technician can manually fill the medication requests and enter input via the MedShelf system indicating that the medication requests have been filled.

In another embodiment, automated systems may facilitate the filling of medication requests. For example, ROBOT-Rx® is a stationary robotic system that automates the medication storing, dispensing, returning, restocking, and crediting process by using various technologies. Operatively, ROBOT-Rx® can receive medication requests from the medication server 100. At the appropriate time, ROBOT-Rx® can guide a picking mechanism to select the desired medications and deposit them in, for example, specific boxes or containers to fill a particular medication request. In response to (e.g., after) filling a medication request, ROBOT-Rx® can transmit a message to the medication server 100, for example, indicating that the medication request has been filled.

As will be recognized, a variety of approaches and techniques may be used for filling medication requests. Accordingly, the foregoing examples are provided for illustrative purposes only and should not be taken in any way as limiting embodiments of the present invention to the examples provided.

### IV. Exemplary System Operation

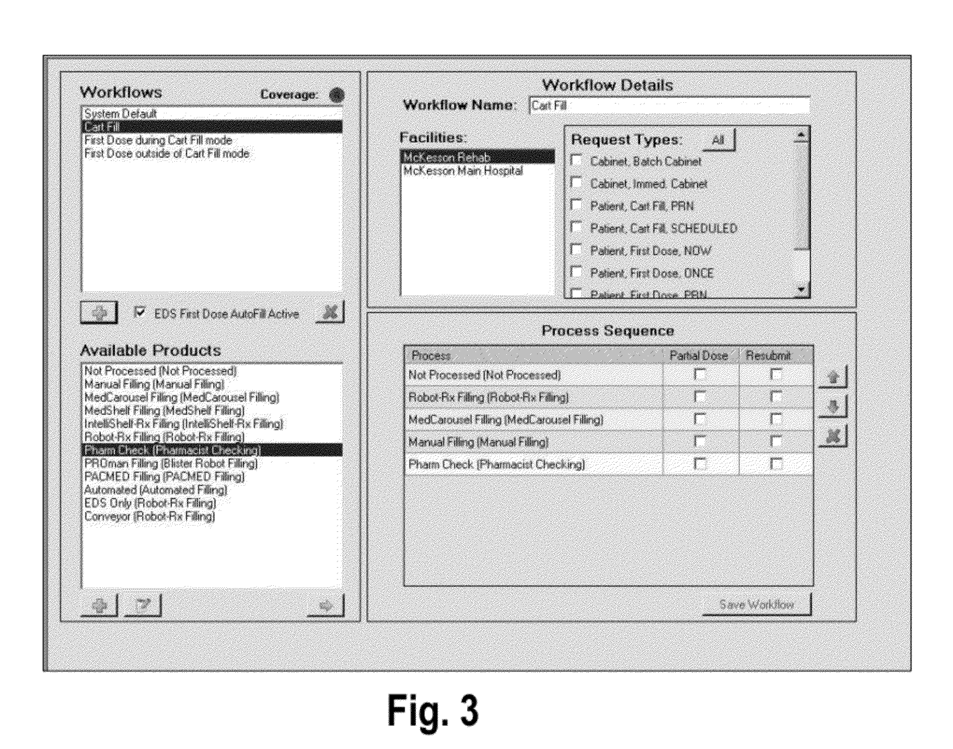

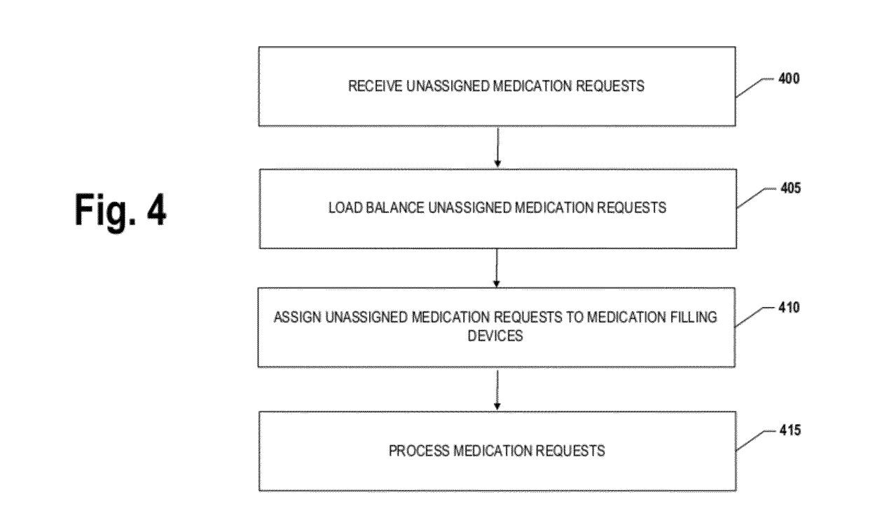

Reference will now be made to FIGS. 3-4. FIG. 3 shows exemplary input/output for load balancing medication requests. FIG. 4 is a flowchart illustrating operations and processes that can be used for load balancing medication requests.

### 1. Exemplary Medication Requests

Patients undergoing medical care or treatment are often placed on medication treatment plans that require them to take one or more doses of medication for a period of time. For example, some medications may require administration at certain times of the day (e.g., after meals) and/or at intervals of one or more hours each day. When a medical provider prescribes medication to a patient, the medical provider can transmit medication requests, for example, to a pharmacy (e.g., medication server 100) for filling. Thus, as indicated in Block 400 of FIG. 4, such medication requests can be routinely, periodically, and/or continuously received by the medication server 100 for filling from a variety of medical providers (e.g., doctors, hospitals, other pharmacies, departments or storage locations within health care facilities, and/or the like).

In one embodiment, to assist in assigning the medication requests to medication filling devices 110 and filling the medication requests, each medication request may include information, such as patient name, patient birth date, patient identification number, patient insurance information, patient allergies, patient location, medication request type, medication request priority, medication filling commit time, types of medications requested, quantities of each medication requested, and/or the like.

Medication requests may be used, for example, to fill prescriptions of patients or to transfer inventory from one location to another. For instance, the medication request type may be used to indicate that the medication request is a patient request or an inventory request. In one embodiment, patient requests may be “cart-fill” requests, “first-dose” requests, and/or the like. A cart-fill medication request may be used to indicate that the medication request is for a patient but is to be filled as part of a batch process of medication requests that, for example, are delivered daily to a hospital, unit in a hospital, and/or health care facility. A first-dose medication request may be used to indicate medication requests that are needed promptly, such as for newly admitted patients or when there is a change to a medication that was cart-filled.

In one embodiment, inventory requests may be “cabinet refill” requests, “inventory transfer” requests, “packaging” requests, and/or the like. A cabinet refill request may be used to indicate that the medication request is to refill a medication cabinet, for example, located at a nursing station within a health care facility. For example, when medication levels in a medication cabinet in a cardiovascular wing are low, a cabinet refill request may be generated to refill one or more medications in the cabinet. An inventory transfer request may be used to provide items to a storage location (e.g., restocking room), and a packaging request may be used to initiate the packaging of medications into unit dose packages. As will be recognized, a variety of other approaches and techniques can be used to adapt to various needs and circumstances.

In one embodiment, the medication server 100 may routinely, periodically, and/or continuously indicate/update the status of each medication request. For example, as indicated, an unassigned medication request may refer to a medication request that has been received but not assigned to a medication filling device 110 for filling. Similarly, an assigned medication request may refer to a medication request that has been received and assigned to a particular medication filling device 110 for filling, but has not yet been filled. Once a medication request has been filled, the medication request may be referred to as a filled or completed medication request. Other potential statuses associated with medication requests may include partially filled, checked, packaged, shipped, and/or the like. Moreover, more than one status may be associated with a medication request. For example, a medication request may be both assigned and partially filled. As will be recognized, a variety of medication request types, approaches, and techniques can be used for receiving and identifying medication requests. In one embodiment, after receiving unassigned medication requests (Block 400 of FIG. 4), the medication server 100 can load balance the medication requests and assign them to medication filling devices 110 for filling based at least in part on the load balancing.

### 2. Exemplary Load Balancing of Medication Requests

In one embodiment, multiple medication filling devices 110 may be used to fill medication requests. As shown in FIG. 3, the medication filling devices 110 to be used for filling medication requests (e.g., all or certain types of medication requests) at any given time may be defined, for example, via one or more workflows (e.g., via the workflow module 270). For instance, a workflow may define (and/or identify) that three ROBOT-Rx® devices (e.g., a first ROBOT-Rx® device, a second ROBOT-Rx® device, and a third ROBOT-Rx® device) can be used simultaneously to fill cart-fill medication requests. As will be recognized, though, any number and combination of medication filling devices 110 may be used simultaneously to fill medication requests. For instance, a MedCarousel® system, a MedShelf system, and an IntelliShelf-Rx® system may all be used simultaneously to fill medication requests. Workflows may also define (and/or identify) the order and manner in which medication requests should be processed. Workflows may also define a variety of other processing parameters, such as the order in which medication requests for certain facilities or patients should be processed. For example, medication requests from a main hospital may have priority over medication requests from a rehab center. Workflows can also be used to define other processing steps/procedures for filling medication requests and various entry states and possible exit states for each workflow. For example, workflows can define how filled and partially-filled medication requests should be checked for accuracy and completed. As will be recognized, a variety of other approaches and techniques can be used to adapt to various needs and circumstances.

In one embodiment, medication requests can be load balanced among any number of defined (and/or identified) medication filling devices 110 (Block 405 of FIG. 4). In various embodiments, load balancing may allow pharmacies to assign medication requests to medication filling devices 110 in a manner that will allow for efficient filling of medication requests and reduce bottlenecks in filling the requests. To load balance medication requests, the medication server 100 (e.g., via the load balancing module 260) may use one or more load balancing parameters/algorithms. The one or more load balancing parameters/algorithms may define/determine how the medication requests should be load balanced (e.g., distributed) among the defined (and/or identified) medication filling devices 110. The load balancing parameters/algorithms may be defined (and/or identified), for example, via one or more workflows. Additionally or alternatively, the load balancing parameters/algorithms may be defined (and/or identified) for use with one or more medication filling devices 110, one or more pharmacies, one or more pharmacists and/or one or more pharmacy technicians, one or more medication filling facilities, and/or the like using mechanisms other than workflows.

In one embodiment, load balancing may include the medication server 100 identifying the medication requests assigned (e.g., assigned medication requests) to medication filling devices 110 that can be used for filling medication requests. For each medication filling device 110, the medication server 100 may determine an estimated fill time to fill each assigned medication request, an estimated fill time to fill substantially all of the assigned medication requests, and/or the like. In that regard, the medication server 100 may routinely, periodically, and/or continuously track/monitor/update medication requests assigned to the medication filling devices 110 (e.g., routinely, periodically, and/or continuously determine estimated fill times for assigned medication requests).

In one embodiment, to determine an estimated fill time to fill the assigned medication requests assigned to a particular medication filling device 110, the medication server 100 may use a variety of factors/data associated with the medication requests. For example, the factors/data associated with the medication requests may include (1) the total number of assigned medication requests, (2) the number of medications requested in the assigned medication request(s), (3) the types of medications requested in the assigned medication request(s), (4) the number of unique medications requested in the assigned medication request(s), (5) the number of bins, envelopes, conveyors, and/or bags needed to fill the assigned medication request(s), and/or the like. For instance, a first assigned medication request may include 10 different medication types and 24 pills of each medication type. As will be recognized, a variety of other factors/data associated with the medication requests may be used to determine estimated fill times.

In one embodiment, to determine an estimated fill time to fill the assigned medication requests assigned to a particular medication filling device 110, the medication server 100 may use a variety of factors/data associated with the medication filling devices 110 as well. For example, the factors/data associated with the medication filling devices 110 may include (1) an estimated time for a medication filling device 110 to move a bin into a scan position and scan its label to begin filling the medication request, (2) the location of each type of medication requested within a medication filling device 110, and/or (3) an estimated time for accessing each type of medication requested (e.g., from a fixed or variable starting point). The factors/data associated with the medication filling devices 110 may also include (4) an estimated speed of a conveyor of a medication filling device 110, (5) an average fill time of a medication filling device 110 for accessing and picking a given medication (e.g., from a fixed or variable starting point), (6) an estimated dispensing time (e.g., time required to package the picked medications), and/or the like. For instance, a ROBOT-Rx® may require 4 seconds to move a bin into the scan position and scan its label to begin filling the medication request. The ROBOT-Rx® may also require 6 seconds to access Acetaminophen and 12 seconds to access Ranitidine. The ROBOT-Rx® may have an average fill time of 9 seconds and estimated dispensing time of 6 seconds. Continuing with the above example, based at least in part on such factors/data, the medication server 100 may determine that the estimated fill time for filling the medication requests (a) assigned to the first ROBOT-Rx® device is 597 seconds (≈10 minutes), (b) assigned to the second ROBOT-Rx® device is 2,709 seconds (≈45 minutes), and (c) assigned to the second ROBOT-Rx® device is 2,272 seconds (≈38 minutes).

In one embodiment, after determining estimated fill times to fill the assigned medication requests assigned to the medication filling devices 110, the medication server 100 may assign a specific number of unassigned medication requests to medication filling devices 110 (Block 410 of FIG. 4). For example, the medication server 100 may assign a single unassigned medication request (e.g., a first unassigned medication request) to the medication filling device 110 with the lowest estimated fill time (e.g., the first ROBOT-Rx® device in this example). Alternatively, the medication server 100 may assign the first 5, 7, 10, or 15 unassigned medication requests in queue to the medication filling device 110 with the lowest estimated fill time (e.g., the first ROBOT-Rx® device in this example). In another embodiment, the medication server 100 may assign the first 5, 7, 10, or 15 unassigned medication requests in queue that are substantially the same type or request substantially similar medications to the medication filling device 110 with the lowest estimated fill time (e.g., the first ROBOT-Rx® device in this example). In one embodiment, after assigning one or more of the unassigned medication requests to a medication filling device 110, the medication server 100 may routinely, periodically, and/or continuously load balance and assign additional unassigned medication requests.

In another embodiment, load balancing may also include the medication server 100 determining estimated fill times for one or more unassigned medication requests. For example, to assign a single unassigned medication request (e.g., a first unassigned medication request), the medication server 100 may determine the estimated fill time of the first unassigned medication request. To assign multiple unassigned medication requests, the medication server 100 may determine the estimated fill times for the first 5, 7, 10, or 15 unassigned medication requests in queue. In one embodiment, to determine an estimated fill time to fill an unassigned medication request, the medication server 100 may use a variety of factors/data associated with the medication requests. For example, the factors/data associated with the medication request may include (1) the total number of medications requested in the unassigned medication request (2) the types of medications requested in the unassigned medication request, (3) the number of unique medications requested in the unassigned medication request, (4) the number of bins, envelopes, conveyors, and/or bags needed to fill the unassigned medication request, and/or the like. As will be recognized, a variety of other factors/data associated with medication requests may be used to determine the estimated fill time. Moreover, to determine the estimated fill time to fill the unassigned medication request, the medication server 100 may use a variety of factors/data associated with one or more medication filling devices 110. As previously discussed, the factors/data associated with the medication filling devices 110 may include (1) an estimated time for a medication filling device 110 to move a bin into a scan position and scan its label to begin filling the medication request, (2) the location of each type of medication requested within a medication filling device 110, (3) an estimated time for accessing each type of medication requested, (4) an estimated speed of a conveyor for a medication filling device 110, (5) an average fill time of a medication filling device 110 for accessing and picking a given medication, (6) an estimated dispensing time, and/or the like. As indicated, the medication server 100 may determine estimated fill times for unassigned medication requests on a singular basis (e.g., the first unassigned medication request in queue) or on a multiple basis (the first 5, 7, 10, or 15 unassigned medication requests in queue). For example, the medication server 100 may determine that the estimated fill time for the first unassigned medication request is 122 seconds (≈2 minutes).

In one embodiment, after determining estimated fill times to fill the assigned medication requests and one or more unassigned medication requests, for example, the medication server 100 may assign the one or more unassigned medication requests to, for example, the medication filling device 110 that would have the lowest estimated fill time if the one or more unassigned medication requests were assigned to it (Block 410 of FIG. 4). Thus, continuing with the above example, the medication server 100 may assign the first unassigned medication request to the first ROBOT-Rx® device as the first ROBOT-Rx® device would have an estimated fill time of 719 seconds (≈12 minutes) if the first unassigned medication request were assigned to it (719 seconds (≈12 minutes)=(597 seconds (≈10 minutes)+122 seconds (≈2 minutes)). As discussed, this need not be done a singular basis, though. For instance, the medication server 100 may assign the first 5, 7, 10, or 15 unassigned medication requests in queue to the medication filling device 110 that would have the lowest estimated fill time if they were assigned to it. In another embodiment, the medication server 100 may assign the first 5, 7, 10, or 15 unassigned medication requests in queue that are substantially the same type or request substantially similar medications to the medication filling device 110 that would have the lowest estimated fill time if they were assigned to it. In one embodiment, after assigning one or more of the unassigned medication requests to a medication filling device 110, the medication server 100 may routinely, periodically, and/or continuously load balance and assign additional unassigned medication requests. As will be recognized, a variety of approaches and techniques can be used.

After load balancing one or more unassigned medication requests and assigning them to medication filling devices 110 for filling, the assigned medication requests can be processed and filled by the corresponding medication filling devices 110 (Block 415 of FIG. 4).

### 3. Exemplary Processing

In one embodiment, as indicated in Block 415 of FIG. 4, assigned medication requests can be processed and filled by the appropriate medication filling devices 110 (e.g., via the processing module 250). For example, the medication server 100 may transmit assigned medication requests to the first ROBOT-Rx® device for filling. As part of the process, a pharmacy technician can view the assigned medication requests via a display (e.g., a dashboard) disposed on or adjacent the first ROBOT-Rx® device. The pharmacy technician can then print out labels and affix them to bins (and/or boxes or bags) and place the bins on a conveyor, for example. Each time a bin is moved into the scan position, the first ROBOT-Rx® device can scan the corresponding label and pick the medications associated with the assigned medication request. After the medications associated with the assigned medication request (e.g., a second assigned medication request) have been picked, the medications may be checked for accuracy and packaged in accordance with the appropriate workflow. If accurately and completely filled, the first ROBOT-Rx® (or other appropriate device) can transmit an indication to the medication server 100 that the assigned medication request (e.g., the second assigned medication request) has been filled. The medication server 100 can then update the status of the second assigned medication request (and its records) to reflect the filling. For example, the status of the second assigned medication request may be changed to filled, which may unassign the second assigned medication request from the first ROBOT-Rx® device. Thus, the second assigned medication request will no longer be assigned to the first ROBOT-Rx® device and will therefore not be used in further load balancing processes and operations.

In another example, a pharmacy technician can view the second assigned medication request via a display (e.g., a dashboard) disposed on or adjacent a MedCarousel® system. The pharmacy technician can then print out a label and affix it to a box, bag, or envelope and scan the label. After the label is scanned, the MedCarousel® system can be used to fill the second assigned medication request. Once the second assigned medication request is accurately and completely filled, a pharmacist or pharmacy technician can enter input via the MedCarousel® system indicating that the second assigned medication request has been filled. The input can then be transmitted to the medication server 100. The medication server 100 can then update the status of the second assigned medication request (and its records) to reflect the filling. For example, the status of the second assigned medication request may be changed to filled, which may unassign the second assigned medication request from the MedCarousel® system. Thus, the second assigned medication request will no longer be assigned to the MedCarousel® system and will therefore not be used in further load balancing processes and operations.

As will be recognized, the preceding examples describe particular embodiments for load balancing, assigning, processing, and/or filling medication requests. The described examples are provided only for illustrative purposes and should not be taken in any way as limiting embodiments of the present invention to the examples provided. Thus, as will be recognized, a variety of other approaches and techniques may be used.

### V. Conclusion

And as will be recognized, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for load balancing medication requests, the method comprising:
identifying, via one or more processors, two or more medication filling devices for filling a plurality of unassigned medication requests;
identifying one or more assigned medication requests assigned to the respective medication filling devices for filling;
for each of the medication filling devices, determining an estimated fill time for filling the one or more assigned medication requests; and
electronically assigning a first unassigned medication request of the plurality of unassigned medication requests to a selected one of the medication filling devices, wherein assigning the first unassigned medication request to the selected medication filling device is based at least in part on the estimated fill times for filling the assigned medication requests.

2. The method of claim 1 further comprising determining an estimated fill time for filling the first unassigned medication request based at least in part on (a) the types of medications requested and (b) the quantity of each type of medication requested.

3. The method of claim 1, wherein determining the estimated fill times for filling the assigned medication requests is based at least in part on (a) the types of medications requested, (b) the quantity of each type of medication requested, and (c) the location within a medication filling device of each type of medication requested.

4. The method of claim 3, wherein (a) determining the estimated fill times for filling the assigned medication requests is further based at least in part on an average fill time of the respective medication filling devices and (b) the unassigned medication requests are processed in accordance with a workflow.

5. The method of claim 1 further comprising:
receiving, via the one or more processors, the plurality of unassigned medication requests; and
filling one of the one or more assigned medication requests via the selected medication filling device.

6. The method of claim 5 further comprising, after filling one of the one or more assigned medication request via the selected medication filling device, unassigning the filled assigned medication request from the selected medication filling device.

7. The method of claim 1, wherein the two or more medication filling devices are identified from a plurality of medication filling devices.

8. A computer program product for load balancing medication requests, the computer program product comprising at least one computer-readable storage medium having computer-readable program code portions stored therein, the computer-readable program code portions comprising:
an executable portion configured to identify two or more medication filling devices for filling a plurality of unassigned medication requests;
an executable portion configured to identify one or more assigned medication requests assigned to the respective medication filling devices for filling;
an executable portion configured to, for each of the medication filling devices, determine an estimated fill time for filling the one or more assigned medication requests; and
an executable portion configured to assign a first unassigned medication request of the plurality of unassigned medication requests to a selected one of the medication filling devices, wherein assigning the first unassigned medication request to the selected medication filling device is based at least in part on the estimated fill times for filling the assigned medication requests.

9. The computer program product of claim 8 further comprising an executable portion configured to determine an estimated fill time for filling the first unassigned medication request based at least in part on (a) the types of medications requested and (b) the quantity of each type of medication requested.

10. The computer program product of claim 8, wherein determining the estimated fill times for filling the assigned medication requests is based at least in part on (a) the types of medications requested, (b) the quantity of each type of medication requested, and (c) the location within a medication filling device of each type of medication requested.

11. The computer program product of claim 10, wherein (a) determining the estimated fill times for filling the assigned medication requests is further based at least in part on an average fill time of the respective medication filling devices and (b) the unassigned medication requests are processed in accordance with a workflow.

12. The computer program product of claim 8 further comprising an executable portion configured to receive the plurality of unassigned medication requests.

13. The computer program product of claim 12 further comprising an executable portion configured to, after filling one of the one or more assigned medication request via the selected medication filling device, unassign the filled assigned medication request from the selected medication filling device.

14. The computer program product of claim 8, wherein the two or more medication filling devices are identified from a plurality of medication filling devices.

15. An apparatus comprising at least one processor and at least one memory including computer program code, the at least one memory and the computer program code configured to, with the processor, cause the apparatus to at least:
identify two or more medication filling devices for filling a plurality of unassigned medication requests;
identify one or more assigned medication requests assigned to the respective medication filling devices for filling;
for each of the medication filling devices, determine an estimated fill time for filling the one or more assigned medication requests; and
assign a first unassigned medication request of the plurality of unassigned medication requests to a selected one of the medication filling devices, wherein assigning the first unassigned medication request to the selected medication filling device is based at least in part on the estimated fill times for filling the assigned medication requests.

16. The apparatus of claim 15, wherein the memory and computer program code are further configured to, with the processor, cause the apparatus to determine an estimated fill time for filling the first unassigned medication request based at least in part on (a) the types of medications requested and (b) the quantity of each type of medication requested.

17. The apparatus of claim 15, wherein determining the estimated fill times for filling the assigned medication requests is based at least in part on (a) the types of medications requested, (b) the quantity of each type of medication requested, and (c) the location within a medication filling device of each type of medication requested.

18. The apparatus of claim 17, wherein (a) determining the estimated fill times for filling the assigned medication requests is further based at least in part on an average fill time of the respective medication filling devices and (b) the unassigned medication requests are processed in accordance with a workflow.

19. The apparatus of claim 15, wherein the memory and computer program code are further configured to, with the processor, cause the apparatus to receive the plurality of unassigned medication requests.

20. The apparatus of claim 19, wherein the memory and computer program code are further configured to, with the processor, cause the apparatus to, further comprising, after filling one of the one or more assigned medication request via the selected medication filling device, unassign the filled assigned medication request from the selected medication filling device.
